(19) United States
(12) Patent Application Publication
(10) Pub. No.: US 2023/0264989 A1
(43) Pub. Date: Aug. 24, 2023

(54) Portable Replenishable Capacitive Deionization Device

(71) Applicant: John J. Gresens, Fernandina, FL (US)

(72) Inventor: John J. Gresens, Fernandina, FL (US)

(21) Appl. No.: 18/112,275

(22) Filed: Feb. 21, 2023

Related U.S. Application Data
(60) Provisional application No. 63/312,729, filed on Feb. 22, 2022.
(60) Provisional application No. 63/312,732, filed on Feb. 22, 2022.

(51) Int. Cl. C02F 1/469

(52) U.S. Cl. CPC C02F 1/4691; C02F 2103/08

(57) ABSTRACT

A portable replenishable scalable capacitive deionization device having a plurality of deionization cells, each of the cells having first and second ends, each of the cells including a cell wall, each of the cells having removable end caps covering the cell first and second ends. Each of the cells having first and second conductive members extending the length of each of the deionization cells, the first conductive member electrically connected to a first current source having negative polarity and the second conductive member electrically connected to a second current source having positive polarity. Each of the deionization cells including first, second and third membranes, the first membrane positioned adjacent the first conductive member, the second membrane positioned adjacent the second conductive member, and the third membrane is positioned between the first and second membranes wherein the first, second and third membranes are removable from each of the deionization cells.

### CROSS-REFERENCE TO RELATED APPLICATIONS

The present application claims priority to U.S. Provisional Patent Application No. 63/312,729, filed Feb. 22, 2022, entitled “PORTABLE WATER PURIFICATION DEVICE,” and further claims priority to U.S. Provisional Pat. App. No. 63/312,732, filed Feb. 22, 2022, entitled “PORTABLE WATER PURIFICATION DEVICE WITH FLOW ELECTRODE,” both of which are by the same inventor as the present application, and all of which are hereby incorporated by reference herein in their entirety.

### FIELD OF THE DISCLOSURE

The present disclosure relates generally to water desalination. More specifically, the present disclosure relates to water desalination along with the removal of other undesirable contaminants that impede the acquisition of potable water using a capacitive deionization device with replenishable components.

### BACKGROUND

Water purification has been a concern around the world for decades. Recent phenomena such as global warming and the heightened awareness to the impact of long outstanding environmental contaminants on water resources have maintained the relevance of processes and devices useful in purifying water.

Over 70% of the earth's surface is covered with water. Of this volume, over 97.5% of this water contains some concentration of salt. This leaves a mere 2.5% of the earth's water as fresh water with then only 1% of the earth's water being easily accessible (US Geological Survey). Global warming and the resulting rising tides have given renewed importance to the sustainability of fresh water resources. The level of salinity in water varies all over the world from the brines found in river basins that meet the oceans of the world to the salt water found in the deep oceans covering large expanses of the earth.

Beyond salinity, there is the problem of contamination of water resources with biological materials and, of late, other materials such as heavy metals like lead, cadmium, and various other chemistries conventionally used in the manufacture of everything from consumer electronics to food stuff packaging. Indeed, some of these chemistries are so ubiquitous in modern life that we are only now coming to realize the problems these chemistries are causing. The combination of environmental contaminants along with the need for potable water may make the provision of fresh potable water a challenging task.

The variance in salinity may range from 0 pounds of salt per gallon of water to saturation with almost 3 pounds of salt per gallon of water. Desalination has previously been addressed using different techniques. The ultimate goal of desalination of water with varying levels of salt has had differing levels of success. Desalination facilities have traditionally been large industrial plants sponsored by state and national governments addressing needs for potable drinking water or irrigating arid land which is desirable for agricultural applications. Smaller devices have also been developed. However, even these smaller devices generally have a price point that is beyond the retail market. Further, any device used for these applications often needs to be as complicated as the variety of environments into which the device is applied. This is a difficult goal to meet for a device that is possibly constrained by size and price.

Another concern that arises from time to time is the discovery of environmental contaminants affecting water resources bound for local communities. Examples of such situations include the leaching of heavy metals into estuaries, aquafers, or reservoirs among other water supply sources. Contaminants may also be found inside the actual sight of consumption. For example, lead pipe and solders were commonly used in many residential and commercial domiciles and buildings for the last century. Indeed, many houses built in the last 100 years still have a lead feed pipe providing the residence with city water.

Efforts at purifying water have varied greatly. Simple mechanical devices have been developed such as that disclosed in U.S. Pat. No. 4,800,018 which shows a filter device which purifies water through gravity flow. Both of U.S. Pat. Nos. 6,344,146 and 8,216,462 combine the structure of reservoir and filter with that of a pump to facilitate water flow through the filter.

Electrical devices include those disclosed in U.S. Pat. No. 6,296,756. The disclosed device uses electrolysis to increase oxygen content in the water to be treated. Another device is disclosed in U.S. Pat. No. 8,816,300 which teaches the use of ultra violet and LED energy to purify water.

Any number of devices have been developed for the purification of water. For example, U.S. Pat. No. 8,043,499 discloses an water purification system using reverse osmosis. The system is designed to work from photovoltaic and wind energy and is portable. Electrodialysis devices disclosed include those of U.S. Pat. Nos. 6,402,917 and 6,537,436. Technology such as electrodialysis and capacitive deionization has been known for some time as a method of purifying water. See, for example, U.S. Pat. No. 7,662,267 which discloses yet another illustration of an electrodialysis device. A series of desalination devices are disclosed in U.S. Pat. No. 11,261,109.

While these developments in the technology of water purification are noteworthy, concerns over economy, size, performance and portability among other considerations persist. As a result, there is a need for further development and solutions in the field of water purification.

### BRIEF DESCRIPTION OF THE DRAWINGS

FIG. 1A is a perspective view of one embodiment of a desalination device showing the device contained within its outer housing.

FIG. 1B is a flow diagram of the process used by the device including the reservoirs for feeding the salt water/brine (feedstock) into the device and the reservoir for feeding the flow electrode, respectively, into the device as well as the reservoirs for receiving the desalinated water, salt/brine, and fluid electrode. Recycle loops for water and the flow electrode are also depicted.

FIG. 1C is a perspective view of the working components of the desalination device shown in FIG. 1A.

FIG. 2 is an exploded view of one embodiment of the desalination cells in the device depicted in FIG. 1C showing the respective fluid and electrical interconnections between cells.

FIG. 3A is a side plan view of one embodiment of an individual cell used in the desalination device.

FIG. 3B is a cut away view of the individual desalination cell shown in FIG. 3A and used in the desalination device.

FIG. 3C is a cutaway view of the cell shown in FIG. 3A interconnected to a cell of identical design depicting fluid and electrical interconnections.

FIGS. 4A-4C are various views of one embodiment of an end cap useful in the desalination device.

FIG. 5A is a perspective view of a further embodiment of an individual cell used in the desalination device.

FIG. 5B is a side plan view of one embodiment of an in-line coupling insert useful in the transmission of the fluid electrode, salt water, and desalinated water through the desalination device.

FIG. 5C is an exploded cutaway side view of one embodiment of a cell useful in the desalination device illustrating the end cap assembly including the in-line coupling of FIG. 4B.

FIG. 6A is a cutaway side plan view of one embodiment of the bottom portion of the device as shown in FIG. 1A showing the seats for the individual cells as well as underlying space for the fluid and electrical interconnection of the individual cells as depicted in FIG. 2.

FIG. 6B is a cutaway side view of one embodiment of the device of the top portion as shown in FIG. 1A showing the seats for the individual cells as well the upper space for the fluid and electrical interconnections of the individual cells as depicted in FIG. 2.

FIG. 7 is a top plan view of one embodiment of the interior of the bottom portion of the desalination device of FIG. 6A. The interior of the top portion of the desalination device is the mirror image of FIG. 7.

FIG. 8 is a side plan view depicting insertion of one embodiment of the cells into the base of the desalination device.

FIG. 9A is a partial perspective view of one half of a cell interior showing a conductive member at the center base of the interior surface of the cell half.

FIG. 9B is a partial top plan view of one embodiment of a membrane support useful in the desalination device.

FIG. 9C is a side cutaway view of the membrane support shown in FIG. 9B taken along axis X-X′.

FIG. 9D is a partial perspective view of one half of a cell interior useful in the desalination device showing the conductive member at the center base of the interior of the cell half and placement of the membrane support within the cell half above the conductive member.

FIG. 9E is a side cutaway view of cell interior shown in FIG. 9D taken along axis Y-Y′.

FIG. 10A is a partial perspective view of one embodiment of a membrane clip useful in the desalination device.

FIG. 10B is a side plan view of the membrane clip shown in FIG. 10A.

FIG. 11A is a partial perspective view of one half of a cell interior of the desalination device showing the conductive member at the center base of the interior of the cell half along with placement of the membrane support within the cell half and placement of the membrane within the membrane support.

FIG. 11B is a side plan view of a partial cell assembly depicted in FIG. 11A.

FIG. 12A is a partial perspective view of one half of cell interior useful in the desalination device showing the conductive member at the center base of the interior of the cell half along with placement of the membrane support within the cell half, further placement of the membrane within the membrane support and placement of a further membrane positioned within the membrane clips at the midpoint of the cell.

FIG. 12B is a side plan view of a partial cell assembly depicted in FIG. 12A.

FIG. 13A is a side plan view of one embodiment of the membrane of FIG. 12A positioned within the membrane clips at the midpoint of the cell.

FIG. 13B is a partial side plan view of a further embodiment of the membrane affixed to the membrane clips and positioned within midpoint rails at the midpoint of the cell.

FIG. 13C is a side plan view of a cell useful in the desalination device shown in FIG. 4A in accordance with one embodiment.

FIG. 14 is a perspective view of a further embodiment of a cell useful in the desalination device of the invention depicting a clam shell orientation with a first side fixed but pivoting around an axis which traverses the length of the cell and a second side which may be opened and closed so as to be water tight.

### DETAILED DESCRIPTION

Levels of salinity in water vary across the globe. Across differing bodies of water “salt water” has differing concentrations of salt depending on season, environmental conditions such as temperature, humidity, and geography. Weather conditions such as drought or monsoon, among other factors may also affect the concentration of salt in water. As a result, there does not tend to be a one size shoe fits all feet solution to desalination. At the same time, the disclosed device may be used in any number of environments and adapted to varying levels of salinity by using varying electrical parameters, water feed rate including the dwell time within the device for the water to be treated as well as any number of secondary filters used to address contaminants other than salt.

Generally, fresh potable water has less than 0.5 ppt of salt while brackish water is considered water with a salinity of about 0.5 to 17 ppt of salt. Seawater may have a salt concentration which ranges radically depending upon ambient conditions. Generally, seawater has a salt concentration ranging from 30 to 40 ppt, on average about 35 ppt. Brine is considered water with a salt concentration over about 50 ppt salt. Here again, the actual salt concentration in water may vary considerably from one body of water to the next given evaporation, freezing, and freshwater runoff among other factors affecting ocean bodies which span miles and project to depths of hundreds of feet.

Briefly, one disclosed device is a portable replenishable scalable capacitive deionization device that includes a salt water inlet and a fluid electrode inlet for receiving water that contains a conductive material. The disclosed device includes a plurality of deionization cells. Each deionization cell includes first and second conductive members extending a length of the deionization cell, with the first conductive member electrically connected to a first current source having negative polarity and the second conductive member electrically connected to a second current source having positive polarity. A first removable membrane is positioned adjacent the first conductive member, a second removable membrane is positioned adjacent the second conductive member, and a third removable membrane is positioned between the first and second membranes. A first channel is positioned lying between the first membrane and the first conductive member, and a second channel is positioned lying between the second membrane and the second conductive member. The first channel and the second channel are operatively coupled to the fluid electrode inlet such that the water containing the conductive material is flowed through the first channel and the second channel. A third channel is positioned lying between the first membrane and the third membrane, and a fourth channel is positioned lying between the second membrane and the third membrane. The third channel and the fourth channel are operatively coupled to the salt water inlet such that salt water is flowed through the third and fourth channels.

As used herein “operative coupling” refers to direct or indirect connections in which one or more intervening parts, pieces, devices, etc. may be used to form a connection between two points. In the case of liquid flow operative coupling, examples of such intervening parts, pieces, devices, etc. may include, but are not limited to, pipes, tubing, hoses, valves, pumps, filters, fittings, regulators, restrictors, flow meters, connectors, etc. In the case of electrical operative coupling, examples of such intervening parts, pieces, devices, etc. may include, but are not limited to, circuit breakers, switches, transformers, relays, connections, plugs, receptacles, fuses, capacitors, diodes, transistors, etc.

In accordance with another aspect of the disclosed device, there is provided a capacitive deionization device having a plurality of deionization cells, each of the cells having first and second ends. Each of the cells has a cell wall and removable end caps covering the cell first and second ends. Each of the cells has first and second conductive members extending the length of each of the cells. The first conductive member electrically connected to a first current source having negative polarity and the second conductive member electrically connected to a second current source having positive polarity. Each of the deionization cells has first, second and third membranes The first membrane is positioned adjacent the first conductive member, the second membrane is positioned adjacent the second conductive member, and the third membrane is positioned between the first and second membranes. The first, second and third membranes are removable from each of the cells. Each of the cells has first, second, third and fourth channels. The first channel lies between the first membrane and the first conductive member, the second channel lies between the second membrane and the second conductive member, the third channel lies between the first membrane and the third membrane, and the fourth channel lies between the second membrane and the third membrane. The capacitive deionization device is connected to a source of water to be desalinated and a source of water comprising conductive material. The water comprising the conductive material is flowed through the first channel and the second channel, and the water to be desalinated is flowed through the third and fourth channels.

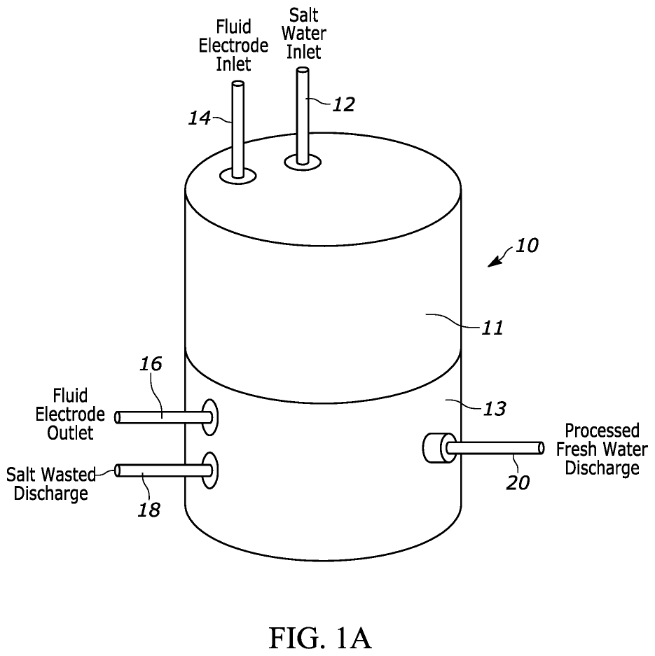

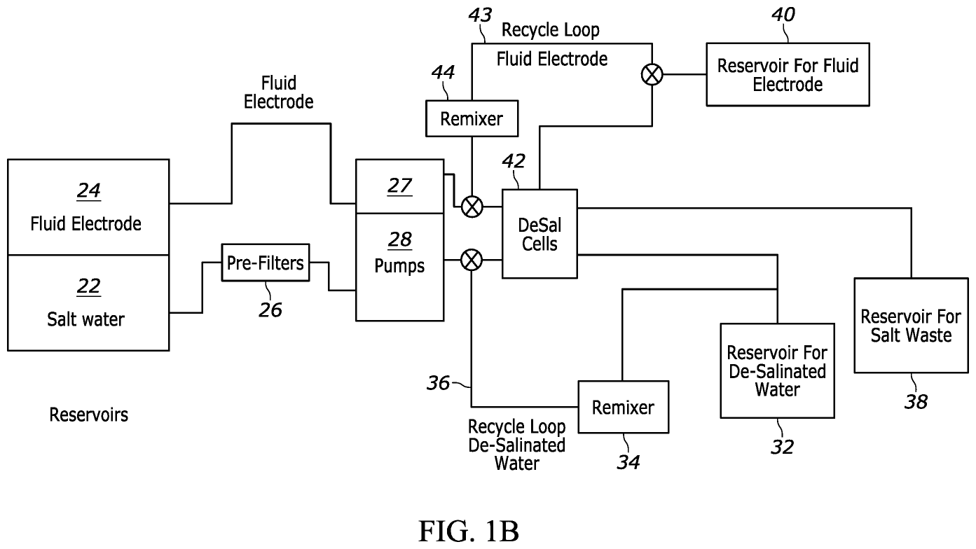

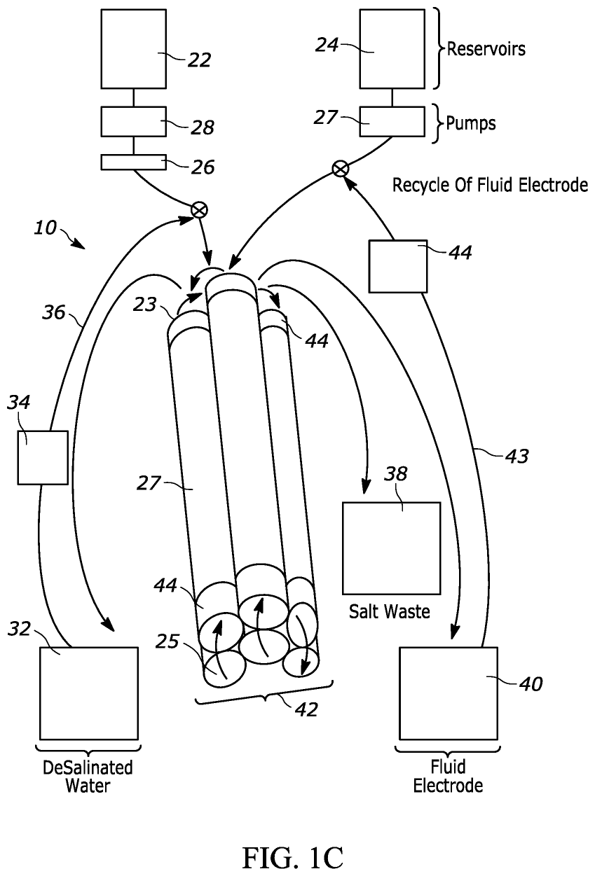

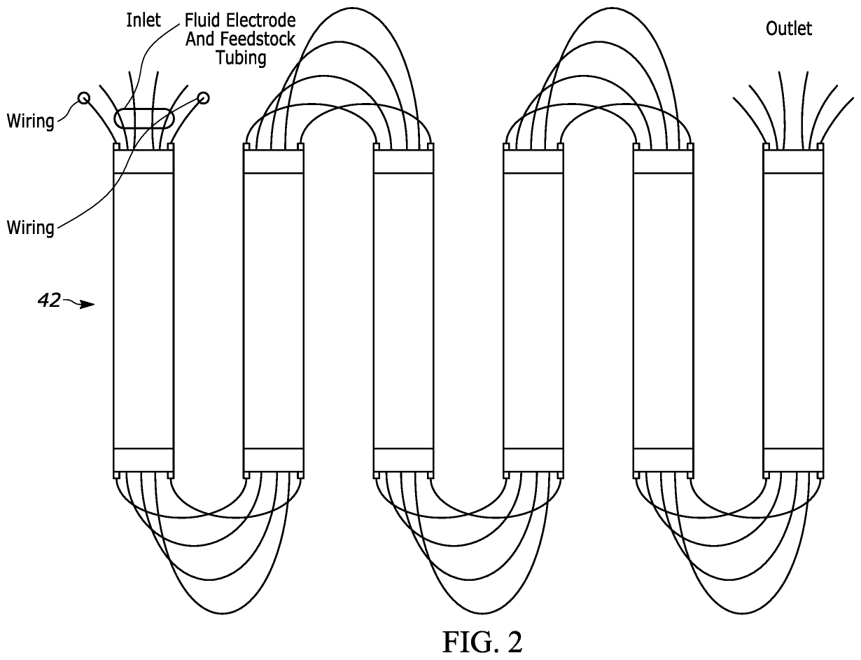

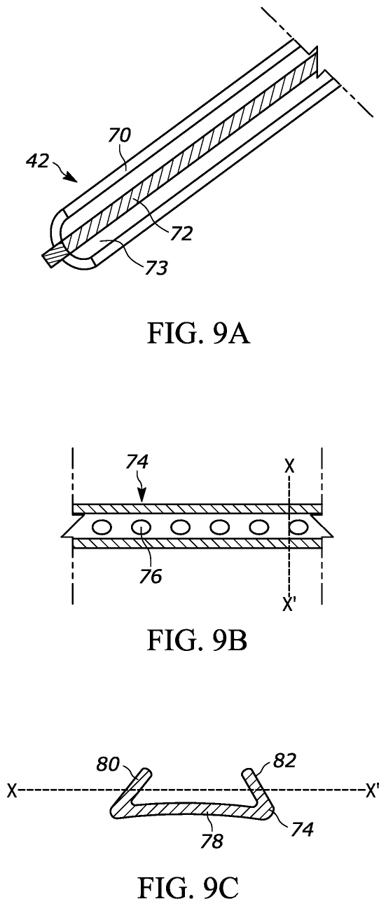

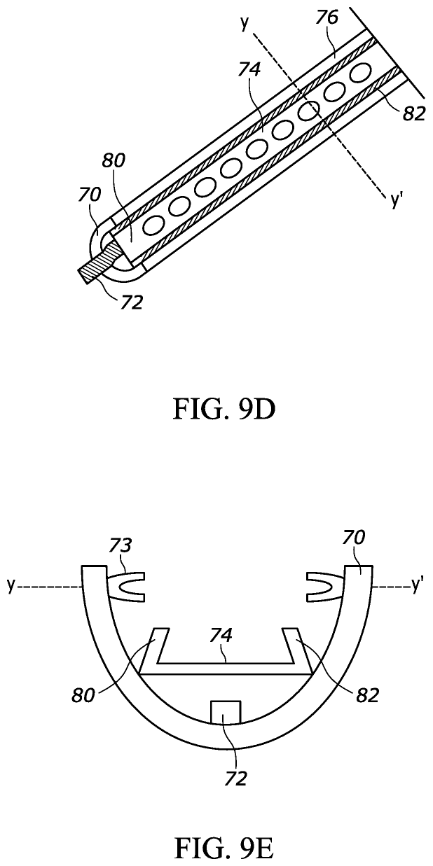

Turning to the Figures wherein like parts are designated with like numerals throughout several views, there is disclosed a capacitive deionization device and process for desalinating water containing some concentration of salt in FIGS. 1A-1C and 2. As the disclosed device is scalable, other water borne contaminants may also be addressed as well. The disclosed device is a portable, replenishable, scalable capacitive deionization device 10 (FIG. 1C) comprising a plurality of deionization cells 42. Each of the cells has a first end 23 and a second end 25. Each of the cells has a cell wall 27, the cell wall has an interior surface and an exterior surface (FIGS. 9A-9E). The cells have removable end caps 44 covering the cell first 23 and second 25 ends.

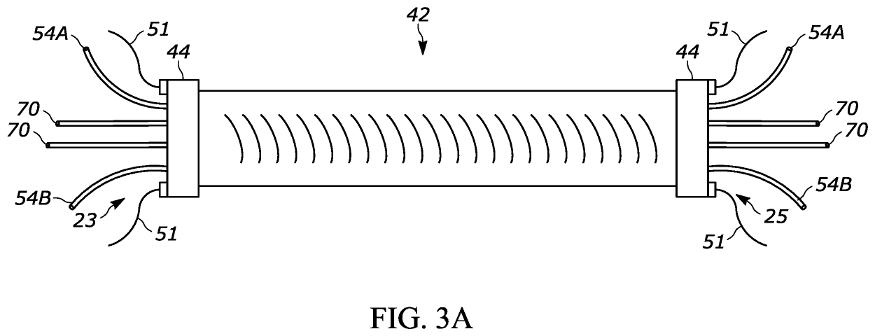

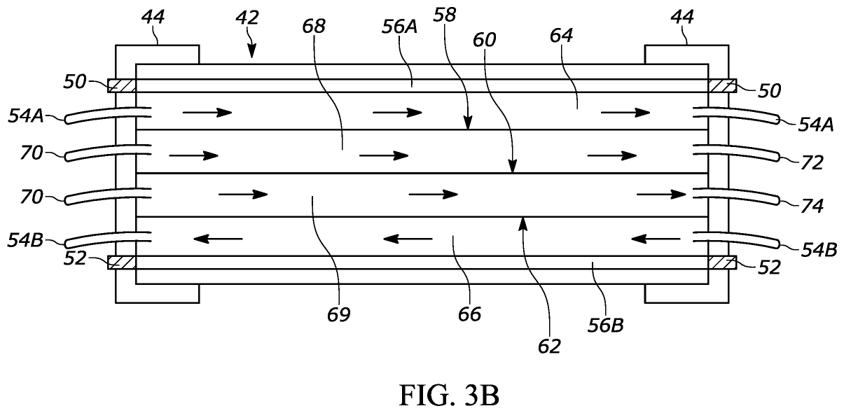

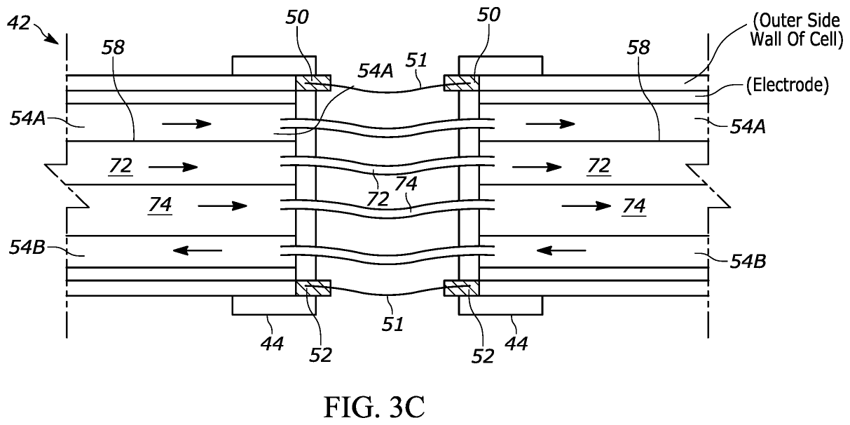

Turning to FIGS. 3A through 3C, there is seen a desalinization cell 42. The cell has first 23 and second 25 ends covered by end caps 44 FIG. 3A. Each of the cells has first and second conductive members 56A and 56B (see FIG. 3B), respectively, extending the length of each of the desalinization cells. The first conductive member 56A is electrically connected to a first current source through contact 50 and has a negative polarity. The second conductive member 56B is electrically connected to a second current source through contact 52 and has a positive polarity.

Each of the desalinization cells has first, second and third membranes, FIG. 3B. The first membrane 58 is positioned adjacent the first conductive member 56A. The second membrane 62 is positioned adjacent the second conductive member 56B. The third membrane 60 is positioned between the first membrane 58 and the second membrane 62. The first, second and third membranes may be replenished (removal and replacement) through removal from each of the desalinization cells.

Each of the cells has first, second, third and fourth channels. The first channel 64 lies between the first membrane 58 and the first conductive member 56A. The second channel 66 lies between the second membrane 62 and the second conductive member 56B. The third channel lies between the first membrane 58 and the third membrane 62. The fourth channel 69 lies between the second membrane 62 and the third membrane 60.

The capacitive deionization device is replenishable and connected to a source of water to be desalinated 22 and a source of water comprising a conductive material 24, the flow electrode, FIGS. 1B and 1C. The water having the conductive material is flowed through the first channel 64 and returned through the second channel 66, FIG. 3B. The water to be desalinated is flowed through the third and fourth channels 68 and 69. The disclosed device may have two reservoirs, the first reservoir for containing the desalinated water 32 and the second reservoir 38 for containing the liquid salt waste, FIGS. 1B and 1C. As can be seen in FIG. 1A through 1C, although not necessary, the disclosed device (FIG. 1A) may be contained within an outer casing 10. The casing may have inlets and outlets. There generally may be an inlet 12 for water comprising salt, (the feedstock), as well as an inlet 14 for the flow electrode. Outlets may include a stop cocked flow electrode outlet 16, a salt waste discharge 18, and a processed fresh water discharge 20, FIG. 1C.

A schematic depiction of the process used in the disclosed device is illustrated in FIG. 1B. Water comprising some concentration of salt (feedstock to be desalinated) is contained within a reservoir 22. An adjacent reservoir 24 contains the flow electrode. The flow electrode reservoir 24 may be stirred as the flow electrode may be water comprising a conductive substance such as graphite. The water comprising salt feedstock may be prefiltered 26 to reduce or eliminate the concentration of larger contaminants (such as organic and inorganic solids) within the feedstock. The feedstock and the flow electrode may then be drawn through respective pumps 27 and 28. As depicted, there may be one pump 28 for the feedstock and another pump 27 for the flow electrode.

From the pump 28, the water comprising salt may enter the desalination cells 42. The flow electrode also enters the desalination cells 42. Processing within the desalination cell is explained subsequently. Once processed, the desalinated water may be decanted off into a reservoir 32. Alternatively, the now once processed water may be recycled 36 back through the desalination cells 42. Recycling the water to be processed through the desalination cells 42 repeatedly is within the scope of the various embodiments. Once the desalinated water has been sufficiently desalinated it may be decanted off to the reservoir 32.

Salt waste resulting from the desalination disclosed device is decanted off into a reservoir 38 for further use or disposal. The flow electrode may either be decanted off into a reservoir 40 or recycled 43 back through the desalination cells 42. As part of the recycle loop 45, a remixer 44 may be used to ensure that the conductive material remains suspended within the flow electrode solution.

An even more detailed view of the inner workings of one embodiment of the disclosed device may be seen in FIG. 1C. As with the process of the device illustrated in FIG. 1B, reservoirs 22 and 24 hold the feedstock water to be desalinated and the flow electrode, respectively. These two solutions are drawn through respective pumps 28 and 27. The salt containing water may then, optionally, be drawn through any number of prefilters 26 depending on the character and quality of the feedstock water to be desalinated.

The flow electrode is drawn from reservoir 24 by pump 27 into the desalination cells 42 and recycled within the cell as shown in FIG. 3B. Once the flow electrode has cycled through the plurality of cells, the flow electrode may be sent through a recycle loop 45. Alternatively, as part of the flow electrode recycle loop the flow electrode may also be drawn off into reservoir 40.

As shown in FIG. 2, the individual desalination cells 42 are in fluid and electrical communication with each other in series. Once the water feedstock has been desalinated this desalinated water may be decanted off into a fresh water reservoir 32. Alternatively, if further processing is necessary the feedstock may be further processed by recycling the feedstock 36 back through the desalination cells 42. Optionally, as the feedstock (water containing salt) is recycled, the feedstock may be remixed 34 before reintroduction into the desalination cells. In turn, the highly concentrated salt containing water may be decanted off on a continuing basis into another reservoir 38. The flow electrode may be decanted off into a further reservoir 40 or, alternatively, recycled 43 back through the desalination cells 42, FIG. 1C.

The connection between the individual cells is illustrated in FIG. 2. As can be seen, the individual desalination cells 42 are interconnected in series. These interconnections facilitate electrical and fluid flow from one desalination cell to the next. This embodiment (FIG. 2) shows six desalination cells. However, depending on the character and quality of the feedstock, more or less desalination cells 42 may be appropriate. It is contemplated that a plurality (at least two) of desalination cells 42 are used in the disclosed device.

Another means of calculating the necessary number of desalination cells is to determine the necessary processing length (inches or centimeters) of cells necessary to fully desalinate the water containing salt feedstock. In order to facilitate portability as well as the ability of the operator to replenish the individual cells, the length of the individual cells may be limited to under 30 inches. FIGS. 3A-3C illustrate an individual desalination cell in accordance with some embodiments. Among other embodiments, the desalination cell 42 may take the design shown in FIG. 3A with interconnectivity as shown in FIG. 2. This embodiment of the desalination cell 42 is distinguished by the use of tubing (54A, 54B, 70) to provide feedstock and the conductive flow electrode which is inserted through the end caps and held in place either by friction or through the use of other means such as adhesive. The cells 42 are electrically interconnected 51 (FIG. 3A) as well.

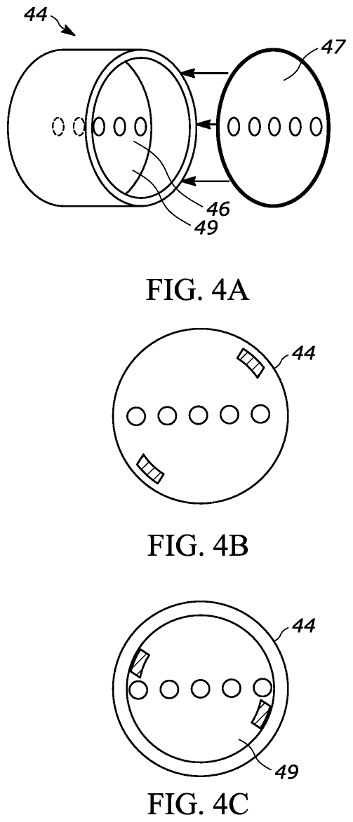

Enough tubing is inserted through holes 46 (FIGS. 4A-4C) in the end caps 44 to allow insertion into the various channels within the cell 42. The individual channels are sealed against the unintended leaking of flow electrode or feed stock across the four channels without proceeding first through the respective three membranes. Additional sealing means 47 (FIG. 4A) may be used to prevent leakage such as foam, putty or rubber. The sealing means may optionally be placed on the interior surface 49 of the end cap 44, FIG. 4A on the surface having the holes 46 for insertion of the tubing. The end caps 44 have holes 46 for the insertion of tubing intended to receive the feedstock and liquid electrode, FIG. 4A-4C. As mentioned, the end caps 44 may comprise additional sealing means 47 such as foam, putty or rubber to prevent the cross contamination of fluid from one channel to another.

As can be seen in FIG. 3B, each desalination cell 42 includes a first 58, second 62 and third 60 membrane. For water desalination the membranes are either cationic selective or anionic selective. Generally, the first and second are the same selectivity being either cationic or anionic selective. The third membrane is selective to the opposite polarity of the first and second membranes. Current collectors 56A and 56B carry either a positive or negative charge, respectively. If collector 56A is charged positively, current collector 56B is charged negatively. Again, the third membrane 60 comprises one polarity and the first and the second membranes 58 and 62 comprise the opposite polarity. Generally, the selection of polarity for the membranes is not consequential as long as both polarities are used in each cell 42. The current collectors 56A and 56B are energized by an electrical power source affixed to contacts 50 and 52 located at either end of each cell 42, FIG. 3B. The electrical power source may be solar, wind power, or conventional sources of electricity.

The desalination cell of the disclosed device also includes first 64, second 66, third 68 and fourth 69 channels. The first 64 and second 66 channels are for transport of the flow electrode adjacent the current collectors 56A and 56B, FIG. 3B. While the flow electrode is intended to be recycled in a continuous loop (43, FIG. 1B) it may also be drawn off to a reservoir 40, FIG. 1B. As can be seen in FIG. 3B, the flow electrode travels in a first direction in channel 64 and in the opposite direction in channel 66.

The third 68 and fourth 69 channels are divided by the third membrane 60. The feedstock water containing the salt enters the desalination cell 42 through the two inlets 70 and then is processed within the cell. The concentrated salt water and recovered desalinated water exits the cell through outlets to channels 72 and 74, FIG. 3B. The outlet used for each of the concentrated salt water and the desalinated water (whether 72 or 74) depends on the configuration (polarity) of the membranes and current collectors.

Any number of alternative arrangements are possible. Using a plurality (two or more) of desalination cells 42, the water containing the salt (feedstock) may be processed by cells arranged in series FIGS. 2 and 3C. Using a larger desalination cell 42 and/or longer feedstock dwell times within the desalination cell 42 it is possible to use fewer desalination cells. It has been found that at least two desalination cells 42 are preferable in the disclosed device. With the use of a plurality of cells 42, the cells may be interconnected as shown in FIG. 3C. As can be seen, wiring 51 between the contacts 50 and 52 of two adjacent cells electrically interconnect the conductive elements of the two desalinization cells shown in FIG. 3C. In turn, tubing interconnects the respective channels 72 and 74 as well as channels 54A and 54B between two adjacent cells 42. Here again, tubing may be held in place by any number of means such as adhesive, mechanical fixtures, or friction fitting. Wiring may be held in place by any means such as solder, conductive adhesive, among other attachment means.

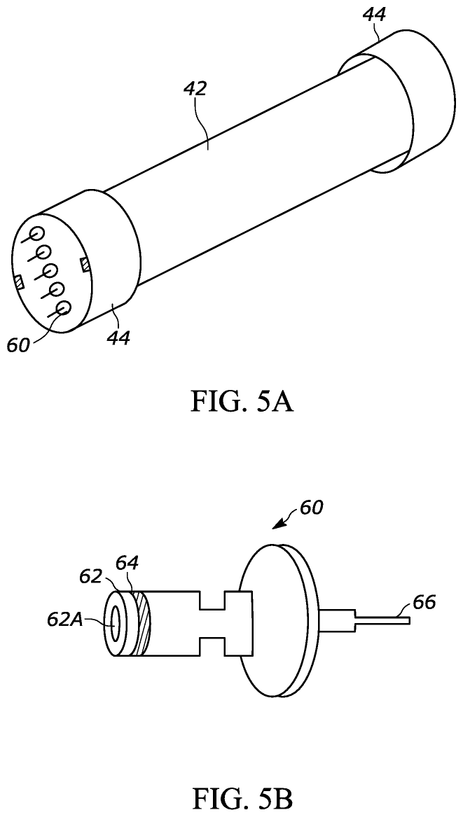

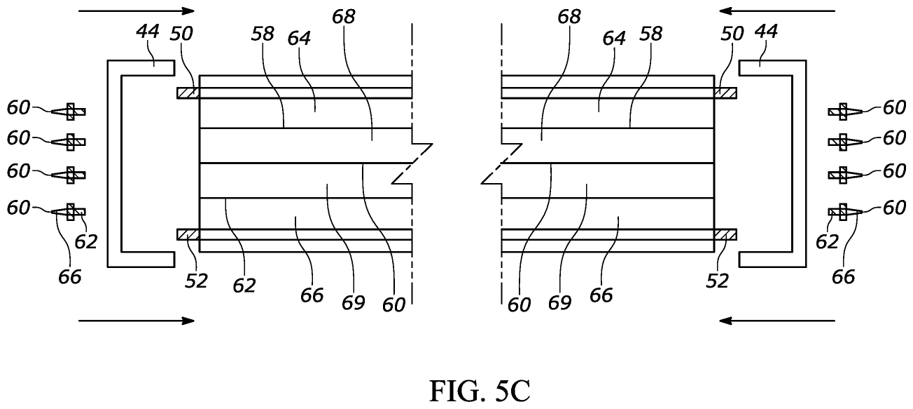

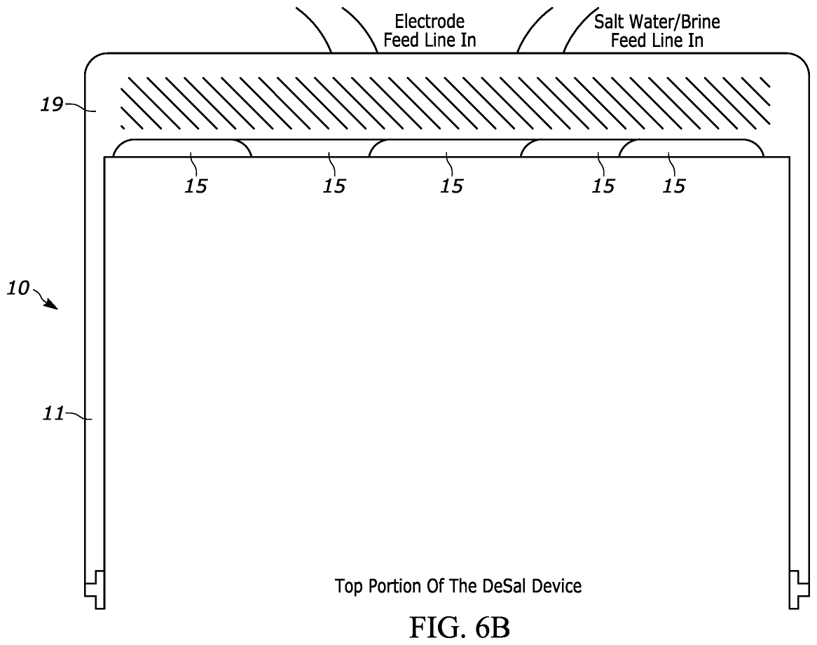

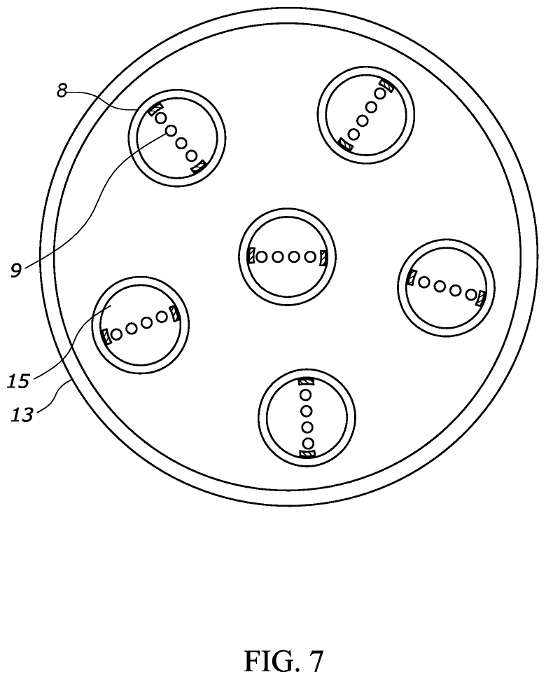

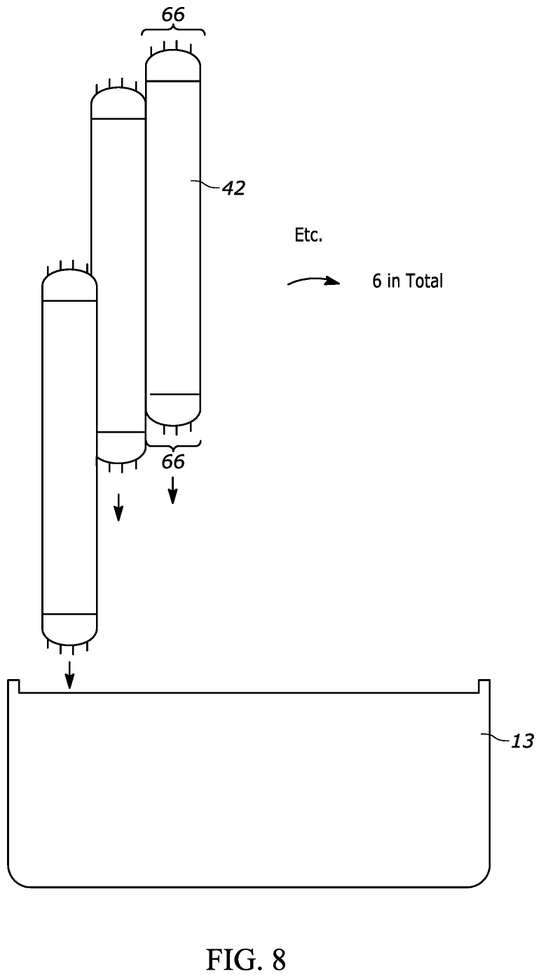

A further embodiment of the desalination cell 42 of the disclosed device is illustrated in FIGS. 5A-5C. In this embodiment, the desalination cell 42 may be used as a “plug-in” element (FIG. 8) in the disclosed device. In this embodiment of the portable replenishable capacitive deionization device, the desalination cells 42 have an assembly and components much the same as the desalination cell illustrated in FIGS. 3A-3C. In this embodiment the end caps 44 have holes 46. In the holes 46, joining elements 60 are inserted, FIG. 5B so that the joining elements protrude into the interior of the cell from the interior surface 49 of the end cap 44. If further extension is desired into the cell tubing may be inserted into opening 62A, FIG. 5B. In this embodiment, joining element end 62 is inserted into the holes 46 in the end caps 44, FIG. 5C. The joining element 60 is held inside the desalination cell 42 by a rubber gasket 64, FIGS. 5A and 5B. Joining element end 66 protrudes 60 from the end cap 44, FIG. 5A.

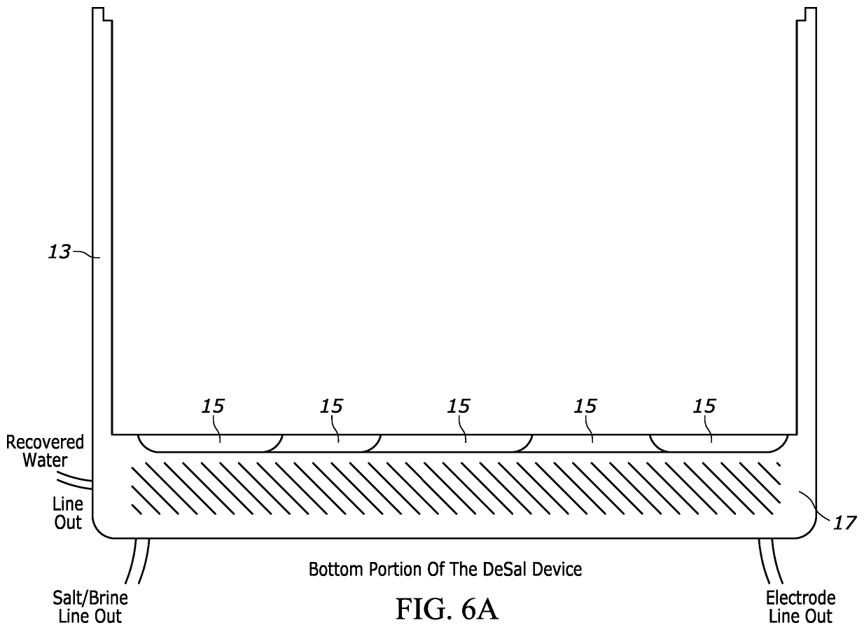

As can be seen in FIG. 5C, this embodiment of the desalination cell of the disclosed device has three membranes (58, 60, 62) four channels (64, 66, 68, 69), two conductive elements (56A and 56B) fed by contacts (50 and 52), as well as inlets and outlets. Instead of external tubing as seen in FIG. 2, the electrical and fluid interconnections between the desalination cells are contained within the outer housing 10 (FIGS. 6A and 6B) as explained herein. The fluid and electrical interconnections between cells are consistent with those illustrated in FIG. 2.

Referring back to FIG. 1, the outer casing 10 may be a two-piece structure having a top portion 11 and a bottom portion 13. Both the top and bottom portions have complementary seats 15 for receiving the desalinization cells 42 of the disclosed device as shown in FIGS. 5A-5C. The seats 15 have receptors 9 for accepting the end 66 of the joining elements 60 and contacts 8 for maintaining electrical connection between the cells, FIG. 7. As can be seen in FIGS. 6A and 6B, the top 11 and bottom 13 portions of the outer casing 10 may fit together in a tongue and groove manner. The patterning of the seats 15 depends on the number of desalination cells 42, (FIG. 5A) used in the device. One example of patterning for the cells 42 may be seen in FIG. 7. In the example embodiment illustrated in FIG. 7, six desalination cells 42 are shown. As shown, the patterning of the seats 15 is for the bottom portion 13 of the outer casing of the disclosed device. The seat pattern for the top portion 11 of the outer casing 10 is the mirror image of the seat pattern for the bottom portion 13 of the outer casing 10.

In this embodiment, the lower interconnections between the desalination cells are housed in the bottom portion 13 of the outer casing in the base 17 beneath the seats 15, FIG. 6A. The upper portion 11 of the outer casing 10 houses the upper fluid and electrical interconnections between desalination cells 42, FIG. 6B in the volume 19 above seats 15. Although not shown in FIGS. 6A and 6B, the patterning of fluid and electrical interconnections between seats 15 in this embodiment of the disclosed device is consistent with, and identical to, the interconnections between desalination cells illustrated in FIG. 2. The desalination cells 42 are then plugged into the bottom portion 13 of the outer casing 10. FIG. 8. The top portion 11 is fit over the desalination cells 42 in a complimentary manner and affixed to the bottom portion 13 of the outer casing 10.

As the disclosed device is modular it may be built out through any number of cells and devices. Given the potential need for added pumping capacity, the pumps may be housed separately. The disclosed device may be provided with increased recovery capacity by adding further cells. A remixer may also be used between any two desalination cells. This allows for the desalination cells of the disclosed device to be used in series to further recover and purify the water to be recovered.

The water to be purified by the disclosed device may be delivered through any number of means including gravity flow, electrical pump, etc. The longer the resident time for the feedstock (water to be recovered) in the cells of the disclosed device, the more efficient the recovery process. A mechanical or electromechanical pump is preferred as allowing the stepped or adjustable means of flowing water to the device given varying levels of salinity. Any number of pumping devices may be used to pump the various fluids through the disclosed device. One family of pumps that have been found useful include those made by Stenner of Jacksonville Fla. Of particular use are the peristaltic metering pumps such as ECON FX and VX.

The power source for the device may take the form of alternating current, direct current or a combination of the two. Preferably, electrical power is used to charge the conductive elements of the disclosed device and any further electrical appliance used with the device such as a pump. The source of electricity may comprise any available resource including solar energy, wind energy, as well as conventional industrial or residential sources of electricity alternating and/or direct current. For example, photovoltaic energy, generator derived energy, nuclear energy, coal based energy, natural gas based energy, etc. may be used.

The cell 42 may be comprised of any material which does not interfere with the intended recovery of water. Plastic polymers such as PVC, ceramics including glass, as well as nonconductive composites and metal alloys, among other materials, are all useful. In cross section the cells may be circular (cylindrical), square, oblong, rectangular, or any other shape which facilitates operation of the device. One source for cell materials is Harrington Industrial Plastics of Jacksonville, Fla. This design of the device facilitates use in domestic/residential environments as well as field use in any number of institutional or governmental applications. The length of the cells may range from about 6 inches to about 30 inches. The width of the cell may range from 1 inch to 5 inches. The cells may be comprised of ceramics such as glass, polymeric plastics such as PVC, or nonconductive metals which will not interfere with the recovery process. End caps may also be obtained commercially through any number of sources such as Harrington Industrial Plastics of Jacksonville Fla. In embodiments formed as cylindrical tubes, the cells may have a contiguous outer surface.

In the production of a system of cells the individual cells may be joined through adhesives or mechanical fixtures, among other means. If the intention is to build a system which is modular, the cells may be affixed to one another in a manner which allows the addition of further cells (or devices) to the original device. Further the disclosed device can be configured to accept membranes which may be replaced if worn over time or if the system is applied to a different environment of use.

Each cell has end caps at either end, each having holes for the introduction of a feed line and two lines for recovered water and saline, respectively. Conductive elements are placed on the interior of either side of the cell adjacent and running the length of the cell. Contacts for the electrodes are placed adjacent the end caps. The contacts allow for electrical connection of the device electrodes to a power source and interconnection of the cells from cell to cell or individually.

Suitable conductive element materials include any conductive material such as copper, and conductive graphite, among other materials. Commercially available materials include conductive graphite available from HP Material Solutions of California and conductive copper tape available made by Tapes Master and available through Amazon or directly from Tapes Master at tapesmaster.com. In one embodiment, a conductive copper foil is placed in the cell running the entire length of the cell and a graphite foil is place over the top of the copper.

The conductive elements may be charged by a DC power source on either side of the cell. Here again, the conductive elements may be charged in series or individually. As the purity and volume of recovered water may vary, use of a step or adjustable or steppable DC power source is preferred. One power source which has been found useful is a Daedalon AC/DC Power Supply available from Science First in Jacksonville Fla., (www.sciencefirst.com).

The relative thickness of the conductive element ranges from about 0.5 mm to about 2 mm. The width of the current collectors generally ranges from about 0.1 mm to about 3 cm. This allows for the necessary dimensions to provide for the necessary voltage and current density to draw the respective contaminant ions through the respective ion selective membranes and out of the fluid stream to be recovered.

Membrane

Water purification using this technology is based on solubility of ions (anions and cations) in water. Unlike poles attract and like poles repel, thus the ions migrate toward the poles of opposite charge. Suitable membranes allow the selective passage of either anions or cations towards the pole of opposite charge.

Suitable membranes may depend on the ionic species to be selected for separation from the fluid to be recovered. In water desalination, generally useful membranes may be classified as cationic or anionic. Membranes may comprise any number of materials. Polymeric materials such as thermoplastic or thermosetting polymers are useful in forming selective membranes in accordance with various embodiments.

Thermoplastic polymers useful in making membranes in accordance with various embodiments include vinyl polymers such as polyethylene, polypropylene, as well as polyesters, polyamides, polyimides, polyamide-imides, polyethers, block polyamides-polyethers, block polyester polyethers, polycarbonates, polysulfones, polybisimidazoles, polybisoxazoles, polybisthiazoles, and polyphenyl polymers. Other thermoplastic polymers which may be useful as membrane material include nylons, polyacetals, poly acetals, polyurethanes, polyphenyl-aniline sulfides, polypropylenes, and poly ether ether ketones among others.

Generally thermoplastic polymers and copolymers comprising monomers including ethylene, propylene, styrene, acrylonitrile, butadiene, isoprene, acrylic acid, methacrylic acid, methylacrylate, methylmethacrylate, vinyl acetate, hydroxy methacrylate, hydroxyl ethyl acrylate as well as other known vinyl monomers.

Membranes useful in the disclosed device may also be fabricated from thermosetting polymers. Useful thermosetting polymer systems in accordance with various embodiments include epoxies, polyurethanes, polyesters, acrylics, bismaleimides such as the reaction product of bismaleimide and methyl dianiline. Other thermosetting polymers that may be used in fabricating membranes useful in the disclosed device include silicones, phenolics, polyamides, polysulfides, curable polyesters, maleate resins that are the reaction product of polyols and maleic anhydride. Maleic anhydride may also be reacted with various acids such as fumaric acid and isophthalic acid among others.

Suitable cationic membranes may comprise monomers of styrene, aniline, vinylchloride, styrene, butadiene, propylene, and ethylene, among other monomers. Representative polymers which may be used as a cationic exchange membrane include polystyrene and polyanaline blends, heterogeneous polyvinylchloride/styrene-butadiene-rubber blends, and monovalent selective membranes made of blends of sulfonated poly(ether sulfone) with sulfonated poly (ether ether ketone. Ceramic cation exchange membranes may also be used such as those synthesized by impregnating ceramic supports with zirconium phosphate or phosphotungstic acid based membranes deposited on graphite supports.

Useful anionic exchange membranes may include, for example, poly(vinyltrimethoxysilane-co-2-(dimethylamine)ethylmethacrlylate)copolymer, membranes composed of 4-vinylbenzyl chloride, styrene, and ethylmethacrylate, cross-linked polystyrene, acrylonitrile/butadiene/styrene with activated carbon and silver fillers, and aliphatic-hydrocarbon based anion exchange membranes prepared from glycidyl methacrylate and divinylbenzene, among others.

Commercially available anionic and cationic ion selective membranes which are useful in the disclosed device include those available from the Fuji Film Membrane Technology Group such as the Type 10 and Type 12 anionic and cationic ion exchange membrane. Preferable are those membranes available from Resin-Tech Inc. such as anionic AMB-SS and cationic CMB-SS both presented as single sheets. The Resin Tech membrane has been found preferable as it provides properties of stability and allows for removability from the cell.

Optionally, the sides of the membrane may be fixed in a membrane support. Membrane supports which have been found useful may be seen in FIGS. 9B and 9C as well as 10A and 10B. As can be seen in FIG. 9A, the conductive member 72 is fixed in the cell 42 on the interior surface 73 of the cell wall 70. Adjacent the conductive member 72 a membrane support 74 is affixed in the cell 42, FIG. 9D. One design of a membrane support that has been found useful is illustrated in FIGS. 9B and 9C. The membrane support has a base 78 and two sidewalls 80 and 82, FIG. 9C. In this instance, the sidewalls are pointed inwardly allowing a membrane to be fixed within the support. At the same time, the membrane may be slidably removed and replaced as needed. The base 78 of the membrane support 74 may have openings 76 to allow for ion flow through the membrane to the conductive member 72. Generally, the membrane support is affixed in the cell 42 adjacent and near the conductive member 72, FIG. 9E.

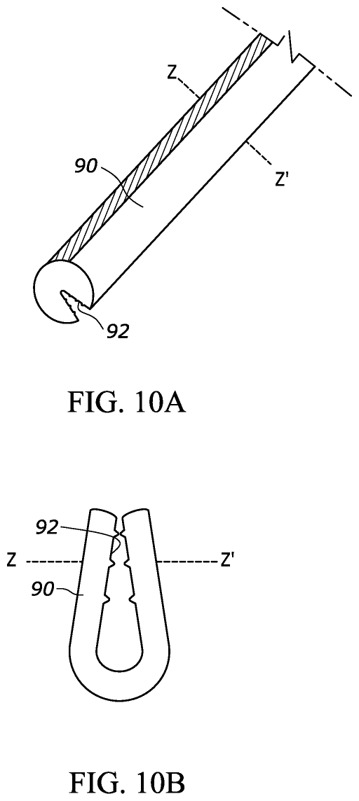

A further example of a membrane support may be found in FIGS. 10A and 10B. Similar to the embodiment of FIGS. 9B and 9C, the embodiment of FIGS. 10A and 10B of a membrane support is mounted on the interior surface 73 of the cell wall 70 above the conductive member 72. In this instance, this membrane support 90 runs the length of cell 42 on either side of the cell 42 and comprises individual elements which face each other so as to accept a sheet of membrane. The membrane support 90 comprises individual teeth 92 which hold the membrane while also allowing the membrane to expand and contract with wetting and drying, FIG. 10B. Given the design of this embodiment, a membrane may be slid into and out of the membrane supports 90.

The membrane may also comprise a bead of polymer on both longitudinal sides of the membrane. Specifically, by placing a small bead of polymer (for example, rubber or cured thermoset adhesive) that portion of the membrane which rests within the membrane support has a structural element which precludes the membrane from pulling away from the membrane support while allowing slidable removal of the membrane from the membrane support.

Assembly

In one embodiment, fabrication of the desalination cells 42 comprises a number of steps. To one section of a cell wall 70, a conductive element 72 is affixed using mechanical means or adhesive, FIG. 9D. Membrane support 74 is next affixed to interior surface 73 of the cell wall 70. The membrane support 74 may have openings 76 to facilitate passage of ions to the conductive element 72 which functions as a current collector to which the support 74 is positioned adjacent. The membrane support 74 may take any number of configurations, FIG. 9C.

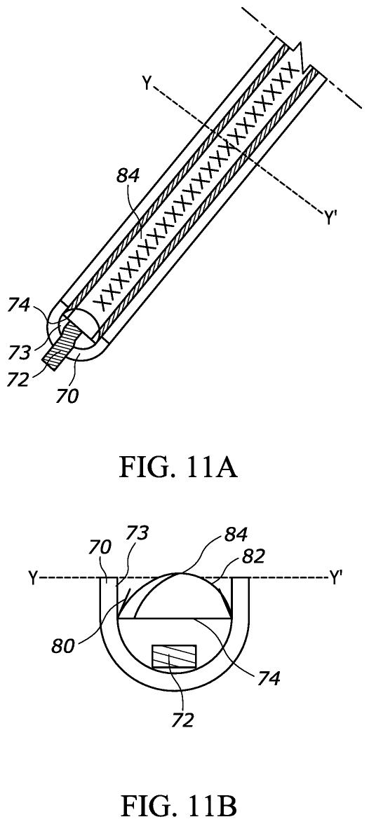

One useful embodiment of the membrane support is shown in FIGS. 9B and 9C. As is seen in cross section, FIG. 9C, the membrane support has a base 78 and two sidewalls, 80 and 82, affixed to the base 78 and directed inwardly across the surface of the base 78 towards each other. The membrane support 74 may be affixed to the inner surface 73 of the cell wall 70 through any mechanical or adhesive means. Membrane 84 may be inserted and held by the membrane support sidewalls 80 and 82 adjacent the conductive element 72, FIGS. 11A and 11B.

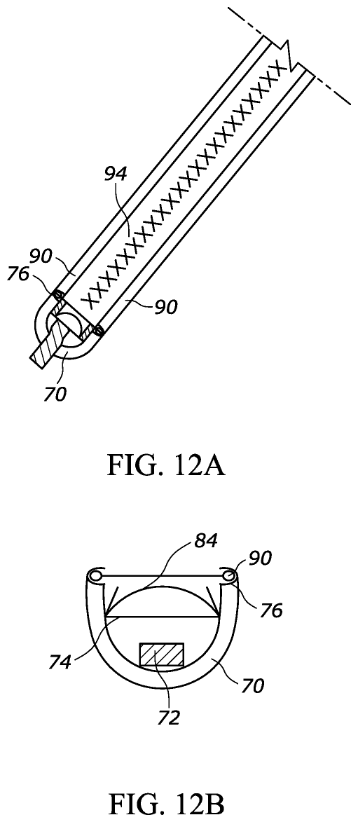

An alternative means of affixing the membranes within the desalination cell is seen in FIGS. 11A and 11B. The clip 90 has a smaller dimension, narrows towards its opening, and comprises interior teeth 92, FIG. 10B. The design of this membrane support 90 allows the expansion and contraction of the membrane as the membrane cycles through use. It is usual for ion exchange membranes to expand when wet and contract when drying. The teeth 92 in the clip 90 also facilitate removal of the membrane over the length of the desalination cell 42 while fixing the membrane in position across the width of the cell 42. The clips 90 may be attached to the surface of the cell housing 70 (FIGS. 9D and 12A) using means such as adhesives. Membrane 94, FIG. 12A may then be inserted into clips 90, FIG. 12A.

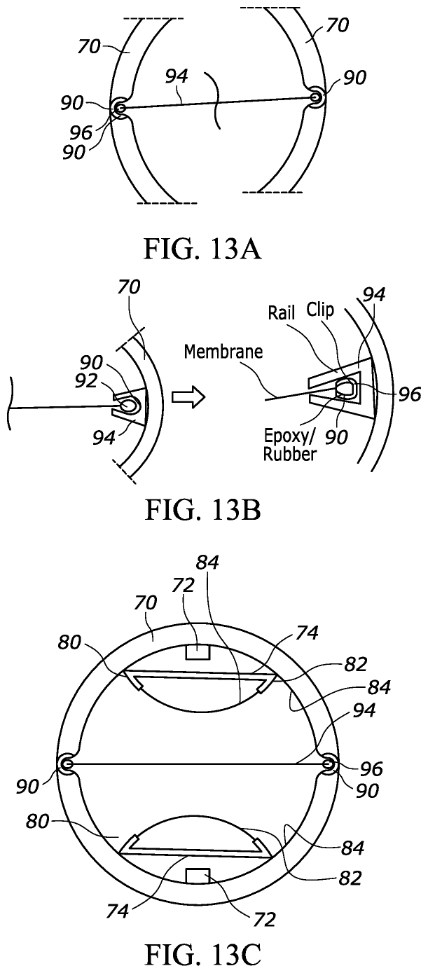

To make the membranes resistant to leakage, the membranes may be grommeted 96 along their entire length on either side of the membrane 94 so that fluid (e.g., water) will not leak around the edges of the membrane that are seated in the clips 90 in the sidewalls of the cell 42, FIGS. 13A-13C. It is within the scope of the various embodiments that all of the membranes are grommeted at the side edges. This design also allows the membranes to be replaced over time to allow for different conditions of use or wear and tear of the membrane.

FIGS. 13A through 13C illustrate the containment of a membrane 94 which has been grommeted within clips 90, FIG. 13A. The desalination cell 42 may also comprise rails 94 running the length of the desalination cell 42. The rails 94 facilitate the insertion and removal of the grommeted membrane 94 which may or may not also be fixed on either side by clip 90. A cutaway sectional view of the completed desalination cell 42 may be seen in FIG. 13C.

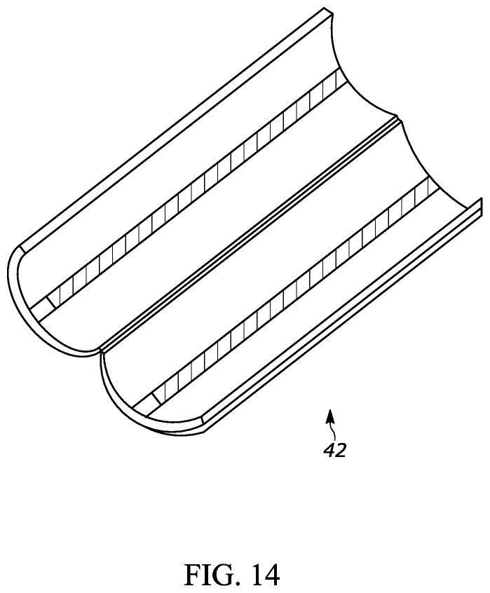

In order to facilitate replacement of component parts the desalination cell may be hinged on one side in a clam shell design, FIG. 14. This design allows easy replacement of membranes as well as service of the desalination cell if the cell falls into disrepair.

### WORKING EXAMPLES

The following examples illustrate certain attributes and properties of the disclosed device.

### Example 1

From a ten-foot length of clear PVC pipe (1.0 inches OD, schedule 40 Harrington Industrial Plastics, Jacksonville Fla.) six twelve-inch sections were cut. Each of the twelve-inch sections were then cut lengthwise in half over their twelve-inch length. One ½ inch strip of conductive copper (Tapes Master Inc., Amazon) tape with adhesive on one side was then laid into each of the twelve sections. The conductive tape was allowed to run past the twelve-inch length on both sides of the section to enable connection from cell to cell as well as connection to a DC power source.

Membrane supports were then fashioned from edge molding commercially available at Ace Hardware, Jacksonville Fla. The molding was cut to 12-inch lengths and the side flanges were trimmed leaving only enough edge to fix the membrane in the support. Holes were punched into the base (base width 0.5 inches at the outer width of the base) of the membrane support to allow the flow of ions within the flow electrode channel. The membrane was then glued into each of the twelve 12-inch half section of PVC pipe adjacent the conductive copper tape using a hot glue (Gorilla Glue Company).

Ion selective membranes (anionic and cationic) were obtained from Resin Tech of New Jersey. Anionic resin (AMB-SS) stock was obtained in single sheets. Cationic resin (CMB-SS) was also obtained in single sheet stock. The respective anionic and cationic membranes were cut to size and mounted on each membrane support. The length of each section membrane was cut at twelve inches. The width of each section of membrane was fashioned so that it is wide enough when fixed in the membrane support to project up from the membrane support but not so far as to make contact with any other membranes. Membrane sections were cut in widths of 0.5 inches×12 inch lengths. Before insertion into the membrane support the outer edges of each membrane was coated with one sixteenth of an inch of epoxy to create an adherent bead. As explained earlier, the epoxy bead was intended to fix the membrane in the support during recovery of the salt water while allowing removal of the membrane when the membrane is in need of replacement. The epoxy was allowed to cure. The membranes were then inserted into their respective membrane supports. The first and second membranes were anionic exchange membranes. The third membrane was a cationic exchange membrane.

The third or central membrane is cut in the same manner as the first two membranes—although larger—and mounted to the sections of each cell as the sections is assembled to form the six cells. Specifically, membrane sections were cut in twelve-inch lengths and—given the width of 12 half sections of pipe −0.75 inches in width. The membrane sections were treated similarly with epoxy creating a bead of epoxy on either side of each membrane section over the length of each membrane. Each membrane was then inserted into two fixing elements on either side of the membrane sections (FIGS. 11A and 11B) (from Out Water Plastics 708-C1 1/16″ Butyrate U-Channel). The fixing elements comprising the membranes were then affixed to the upper side edges of six of the PVC pipes using hot glue (Gorilla Glue Company) along the entire length of both edges of each of the six half pipes. The six two membrane and six one membrane PVC halves were then attached to each other using a water proof sealing tape (Gorilla Glue Company) running the length of each section at the seams between the two halves.

Four holes were drilled in each of the twelve end caps (Harrington Industrial Plastics, Jacksonville Fla.) and a twelve-inch length of clear vinyl tubing ( 5/32 inch OD) was inserted through each of the holes in each of the end caps. The tubing extended about an inch into the interior of each end cap. Once four sections of tubing were inserted into each end cap, the interior of each end cap was lined with silicone putty (E/FUSING 900 Moldable Silicone Putty) at the surface that the tubing was inserted through. The putty served two purposes; fixing the tubing in place in the end cap and sealing the membranes against leakage and cross contamination.

The two half sections of the cell were combined to form each of the six cells and the end caps were attached at either end of each of the cells feeding each of the four sections of tubing into the four channels. The two conductive members were wrapped around the sides of each respective cell half to enable further connection between cells and to the power source. Connectors (Harrington Industrial Plastics, Jacksonville Fla.) to make the tubing connections between the cells as well as to connect the cells to the source of salt water (preprocessing) and the discharge reservoirs (postprocessing). The tubing in the six cells was then connected together using connecters (Harrington Industrial Plastics, Jacksonville Fla.). The six cells were connected in series as well as to the pumps used to create flow to the six cells which were attached in series.

Water flow was facilitated using three Model ECON FX Pumps (85MPH5) made by Stenner of Jacksonville Fla. The flow rates ranged from 0.2 gpm to 15.1 gpm for the water needing purification and the flow electrode. From the reservoirs (flow electrode and feedstock water for recovery) these respective fluids passed through a prefilter and then to the pump. From the pump, the water to be recovered was flowed into the cells. Once through the cells the water was decanted off, recovered water in one vessel and concentrated saline in another. At the same time water is flowed through an immediately adjacent channel which through the flow electrode drew and concentrated saline ions into the channel and flushed from the system.

From a further reservoir, the fluid electrode was dispensed. This fluid was a mixture of conductive carbon particles suspended in water. The fluid electrode was flowed between the conductive copper member and the membrane in a continuous loop through the anionic and cationic sides of the cell through which they are connected. After coming through both sides of the cell the fluid electrode was subjected to a remixer. A 2500 ml Erlenmeyer flask having an input for receiving the water/carbon particle mixture and an output allowing the fluid electrode to be pumped back into the cells was used as a remixer. The addition of further volumes of flow electrode was controlled by a stop cock. This mixing vessel was used to enhance the homogeneity of the carbon particles in the flow electrode. The concentration of the conductive particles in the water conductive particle mixture ranged from 1% to 5% w/v. The system used was a vessel or flask with a double-hose barbs to allow the flow electrode in for mixing/remixing and out for introduction back into the flow electrode channel. Mixing in the flask was undertaken using Intllab Magnetic Stirrer. The recovered water was tested for salinity and recycled through the system.

Because concentration polarization becomes more important as the solution becomes more dilute, the solution velocity increases in the stacks processing the most dilute solution. The velocity of the solution was controlled using the pump which is stoppable and can be adjusted to provide a slower or faster rate of fluid flow. Typically, large recovery systems have 6-10 cells in series to achieve the recovered water. This will depend on salinity, weather, and other environmental conditions. For applications requiring high purity water, the disclosed device may be run in series with the flow electrode, recovered water, and concentrated saline flowing from one device to the next. The fluid and electrical connections were discrete to each set of cells. Electrical connections may also be configured in series across the entire system.

### Example 2

Six further cells were assembled in a manner which was identical to Example 1 with one exception. Instead of using conductive copper foil as the conductive member, conductive graphite (GOONSDS Graphite Sheets Foil 0.1 mm) strips were cut from graphite sheets. The graphite sheets were cut in twelve-inch lengths and 0.5-inch widths. The cells were connected in series and the salt water was processed as described in Example 1.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A portable replenishable scalable capacitive deionization device comprising:
a salt water inlet;
a fluid electrode inlet for receiving water comprising conductive material;
a plurality of deionization cells, each deionization cell comprising:
first and second conductive members extending a length of the deionization cell, with the first conductive member electrically connected to a first current source having negative polarity and the second conductive member electrically connected to a second current source having positive polarity;
a first removable membrane positioned adjacent the first conductive member, a second removable membrane positioned adjacent the second conductive member, and a third removable membrane is positioned between the first and second membranes,
a first channel lying between the first membrane and the first conductive member, a second channel lying between the second membrane and the second conductive member, the first channel and the second channel operatively coupled to the fluid electrode inlet such that water comprising conductive material is flowed through the first channel and the second channel; and
a third channel lying between the first membrane and the third membrane, and a fourth channel lying between the second membrane and the third membrane, the third channel and the fourth channel operatively coupled to the salt water inlet such that salt water is flowed through the third and fourth channels.

2. A portable replenishable scalable capacitive deionization device comprising:
a plurality of deionization cells, each of said cells having first and second ends, each of said cells comprising a cell wall, each of said cells comprising removable end caps covering said cell first and second ends,
each of said cells having first and second conductive members extending a length of each of said deionization cells, said first conductive member electrically connected to a first current source having negative polarity and said second conductive member electrically connected to a second current source having positive polarity,
each of said deionization cells comprising first, second and third membranes, said first membrane positioned adjacent said first conductive member, said second membrane positioned adjacent said second conductive member, said third membrane is positioned between said first and second membranes wherein said first, second and third membranes are removable from each of said deionization cells,
each of said cells having first, second, third and fourth channels, said first channel lying between said first membrane and said first conductive member, said second channel lying between said second membrane and said second conductive member, said third channel lying between said first membrane and said third membrane, said fourth channel lying between said second membrane and said third membrane, and
wherein said replenishable capacitive deionization device is connected to a source of water to be desalinated and a source of water comprising conductive material, wherein said water comprising said conductive material is flowed through said first channel and said second channel, and said water to be desalinated is flowed through said third and fourth channels.

3. The device of claim 2 additionally comprising first and second reservoirs, said first reservoir for containing the desalinated water and said second reservoir for containing a liquid salt waste.

4. The device of claim 2, wherein said first and second membranes each comprise first and second edges, each of said membrane first and second edges comprise a sealing element.

5. The device of claim 2, wherein said third membrane comprises first and second edges, each of said membrane first and second edges comprise a sealing element.

6. The device of claim 3, additionally comprising a third reservoir for containing the water comprising the conductive material.

7. The device of claim 2, comprising six deionization cells.

8. The device of claim 7, wherein said six deionization cells are interconnected electrically.

9. The device of claim 7, wherein said six deionization cells are interconnected allowing fluid flow from cell to cell.

10. The device of claim 2, wherein the first current source and the second current source are provided by a source of energy selected from the group consisting of: electricity derived from wind based energy, photovoltaic energy, generator derived energy, nuclear energy, coal based energy, natural gas based energy or combinations thereof.

11. The device of claim 2, wherein said deionization cell comprises a cylindrical tube comprising an interior wall.

12. The device of claim 11, wherein said deionization cell comprises a first half and a second half joined along the length of the deionization cell, said first half comprising an interior wall and said second half comprising an interior wall, said first conductive member affixed to said cell first half interior wall, said first membrane affixed to said cell first half interior wall adjacent said first conductive member forming said first channel, said second conductive member affixed to said cell second half interior wall adjacent said second conductive member forming said second channel, said third membrane affixed between said deionization cell first and second halves in said deionization cell third channel.

13. The device of claim 12, wherein said first and second deionization cell halves are joined together along their lengths to create a cylindrical tube with a contiguous outer surface.

14. The device of claim 4, wherein the sealing element comprises a cured adhesive.

15. The device of claim 4, wherein the sealing element comprises a polymeric rubber.

16. The device of claim 2, wherein the conductive member comprises copper.

17. The device of claim 2, wherein the conductive member comprises conductive graphite.

18. The device of claim 2, additionally comprising first and second membrane supports, said first membrane support positioned adjacent said first conductive member and supporting said first membrane, said second membrane support positioned adjacent said second conductive member and supporting said second conductive member.

19. The device of claim 18, wherein said first and second membranes are friction fit within respective first and second membrane supports.
